(19) United States
(12) Patent Application Publication
(10) Pub. No.: US 2015/0308643 A1
(43) Pub. Date: Oct. 29, 2015

(54) ELECTRONIC LIGHT-EMITTING DEVICE

(71) Applicant: YING-CHIH HUANG, New Taipei City (TW)

(72) Inventor: YING-CHIH HUANG, New Taipei City (TW)

(21) Appl. No.: 14/262,261

(22) Filed: Apr. 25, 2014

(51) Int. Cl. F21S 10/04; F21S 9/00; F21V 23/00; F21S 6/00; F21V 14/02

(52) U.S. Cl. CPC F21S 10/046; F21S 6/001; F21V 14/02; F21V 23/008; F21S 9/00

(57) ABSTRACT

An electronic light-emitting device includes a housing. An upper end of the housing has an opening, and a positioning rod is connected to an upper inner side of the housing. The positioning rod is mounted by a holder via a through hole. An upper end of the holder has a flame decoration sheet extended to expose outside the opening. A light-emitting unit is provided at the inner side of the opening of the housing to radiate the flame decoration sheet. A lower inner side of the housing has a swinging member and a driving member. A lower end of the housing is connected to a seat. The swinging member has a magnetic element, and an extension section at an upper end thereof that touches and pushes the lower end of the holder. The driving member is disposed to correspond to the magnetic element.

### FIELD OF THE INVENTION

The present invention relates to a light-emitting device, and particularly to an electronic light-emitting device that replaces a conventional candle.

### BACKGROUND OF THE INVENTION

Candlelight of candles had long been a main lighting tool of the people for the night since the medieval times until gradually being replaced by electric lights in the Second Industrial Revolution (also known as the Age of Synergy). However, in addition to emergency uses during blackout, candlelight is still widely used in the daily life for purposes of decoration and pleasure. For example, candles are traditionally used in ceremonial occasions such as weddings, anniversaries and funerals, special holidays, and religious occasions. Ornamental candles offering decorative functions and scented candles offering different atmospheres are now available on the market.

During the recent years, electronic candles are applied in the conventional candle market in the view of eliminating environment and safety issues including odor from burning and fire accidents of conventional candles. In an electronic candle, an electronic light source is combined with decorative pieces to simulate glimmering and flickering effects of conventional candlelight. However, comparing with conventional candlelight, changes of an electronic light source and swings of decorative pieces are too regular to provide realistic visual effect. A market-available electronic candle, for example, an electronic light-emitting device disclosed by China Publication No. CN101865413A, includes a core, an enclosure and a chassis. A first magnet and an induction coil are provided at a bottom of the core, and a linkage rod is provided in the core. A second magnet corresponding to the first magnet is provided at a lower portion of the linkage rod. Above the core is a flame sheet, which is penetrated through and suspended by a flame sheet pole. A third magnet and a fourth magnet corresponding to each other are provided above the linkage rod and below the flame sheet. A PCB motherboard and a power supply unit are provided in the chassis.

When a control circuit on the PCB motherboard sends out a pulse that passes the induction coil and the first magnet, the second magnet at the linkage rod is swung due to magnetic induction, which further drives the third magnet and the fourth magnetic to produce magnetic induction, thereby swinging the flame sheet. However, as a result of the PCB motherboard and the power supply unit, the electronic device correspondingly has a greater volume that occupies a greater space, and requires a larger load and higher manufacturing costs. Further, as the flame sheet produces limited swinging movements due to the flame sheet pole and magnetic attraction and repulsion, the swinging movements of the flame sheet may appear too artificial when one observes the movements for a period of time. In addition, in an occasion where a large number of electronic light-emitting devices are utilized, wastes caused by a large number of the same functional elements that have to match the sockets one-on-one are generated and burden an addition load to the environment.

### SUMMARY OF THE INVENTION

Therefore the primary object of the present invention is to provide an electronic light-emitting device that replaces a conventional candle and offers better utilization safety.

Details of the technical solution of the present invention for achieving the above object and solving issues of the prior art are described below. An electronic light-emitting device of the present invention includes a housing. An upper end of the housing is provided with an opening. A positioning rod is connected to and provided at an inner side of the housing and close to the opening. A holder provided with a through hole is penetrated by the positioning rod and thus mounted on the positioning rod. An upper end of the holder is provided with a flame decoration sheet that is extended to expose outside the opening. A light-emitting unit is provided at the inner side of the housing and close to the opening. A radiating surface of the light-emitting unit is corresponding to a side surface of the flame decoration sheet. A swinging member is provided at the inner side of the housing and away from the opening. Each of two sides of the swinging member is provided with a shaft connected to the inner side of the housing. The swinging member is connected to a magnetic element. An upper end of the swinging member is extended to form an extension section that correspondingly touches and pushes a lower end of the holder. The driving member is provided at the inner side of the housing to correspond to the magnetic element. A lower end of the housing is connected to a seat.

The electronic light-emitting device of the present invention achieves the following effects.

First of all, the electronic light-emitting device of the present invention is capable of replacing conventional candle, and thus preventing fire accidents and human body burnt hazards.

Secondly, when utilizing the electronic light-emitting device of the present invention, as the through hole of the holder is abutted by a pointed section of the positioning rod, and swinging movements of the holder are produced from the swinging member touching and pushing the holder, the flame decoration sheet of the holder is driven to produce irregular movements that better simulate real visual effect of a flickering and swaying flame.

Further, according to the application of the seat, the electronic light-emitting device may be implemented in a separate or integral form. With the swinging member, the flame decoration sheet may have a swinging or non-swinging design. In the integral form, a power supply unit and a control unit are provided in the seat to control the power supply of the electronic light-emitting device. In the separate form, the seat is applied to operate with a socket. For example, a plurality of sockets that can be correspondingly inserted by the pins respectively are provided at the lamp seat. As such, the lamp seat may be inserted by a plurality of electronic light-emitting devices. With the control unit and the power supply unit in the lamp seat, the power supply and the swinging changes of the electronic light-emitting devices can be controlled at the same time, thereby reducing volume, weight and production costs of the electronic light-emitting device of the present invention.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the present invention;

FIG. 2 s a partial exploded sectional view of the present invention;

FIG. 3A is a perspective view of the present invention;

FIG. 3B is a sectional view along 3B-3B of FIG. 3 and a schematic diagram of a swinging member in a position before swinging;

FIG. 3C is a schematic diagram of a protrusion touched and pushed by a swinging member of the present invention;

FIG. 4 is a schematic diagram of an embodiment of the present invention applied to a lamp seat;

FIG. 5 is an exploded view of a seat according to another embodiment of the present invention;

FIG. 6 is a sectional view of an electronic light-emitting device in an integral form according to an embodiment of the present invention;

FIG. 7 is a sectional view of an electronic light-emitting device in a separate form according to an embodiment of the present invention; and

FIG. 8 is a sectional view of an electronic light-emitting device in an integral form according to another embodiment of the present invention.

### DETAILED DESCRIPTION OF THE PREFERRED EMBODIMENTS

In the description below, it is to be noted that similar elements are represented by the same denotations.

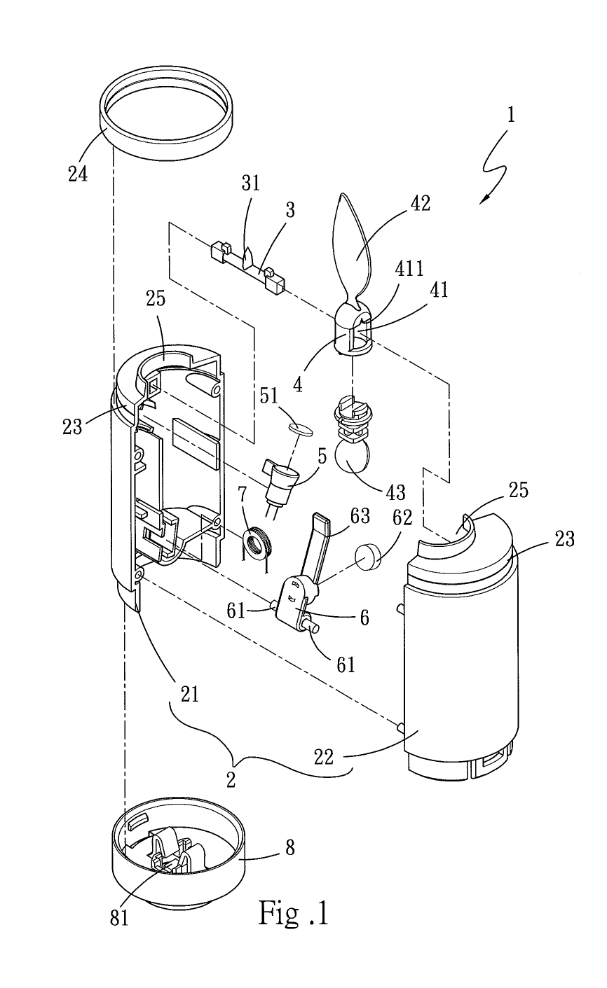

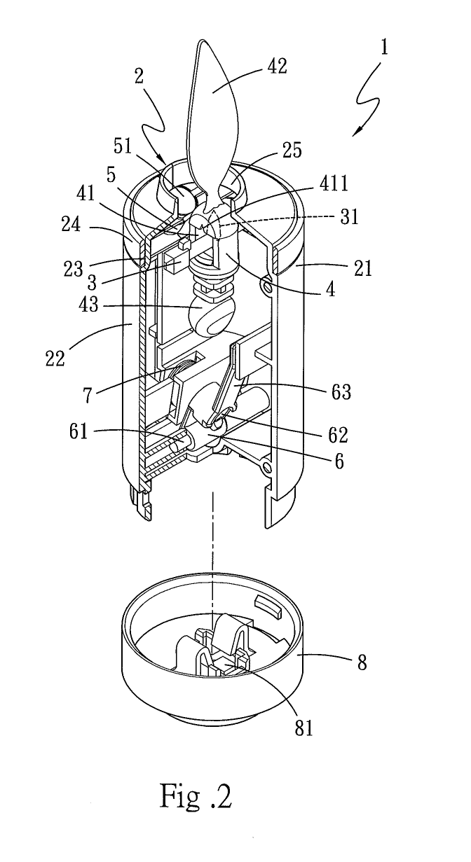

FIG. 1 to FIG. 3C show an electronic light-emitting device of the present invention. Referring to FIG. 1 to FIG. 3C, an electronic light-emitting device 1 includes a housing 2, a positioning rod 3, a holder 4, a light-emitting unit 5, a swinging member 6, a driving member 7, and a seat 8.

The housing 2 includes a first cover 21 and a second cover 22 that can be correspondingly fastened to each other. An embedded groove 23 is provided on an upper periphery of each of the first cover 21 and the second cover 22. A fastening ring 24 is coupled on and fastened around the embedded grooves 23 of the first cover 21 and the second cover 22. An opening 25 is provided between an upper end of the first cover 21 and an upper end of the second cover 22.

The positioning rod 3 is disposed at an inner side of the housing 2 and close to the opening 25. Further, the positioning rod 3 has two ends respectively connected to an inner side of the first cover 21 and an inner side of the second cover 22, and a middle part of an upper end provided with a protruding pointed section 31.

The holder 4 is provided with a through hole 41. A top wall of the through hole 41 is provided with a recess 411 that corresponds to the pointed section 31. An upper end of the holder 4 is provided with a flame decoration sheet 42. A lower end of the holder 4 has a protrusion 43. The holder 4 is penetrated by the positioning rod 3 via the through hole 41 to be mounted on the positioning rod 3, and the flame decoration sheet 42 passes through the opening 25 to be exposed outside the housing 2. The recess 411 of the through hole 41 is abutted by the pointed section 31 of the positioning rod 3, such that the holder 4 forms irregular movements on the positioning rod 3.

The light-emitting unit 5 is disposed at the inner side of the housing 2 and close to the opening 25, and is clamped between the first cover 21 and the second cover 22 to be fastened in the housing 2. A front end of the light-emitting unit 5 is provided with a convex lens 51 through which a radiating light area can be enlarged. A radiating surface of the light-emitting unit 5 forms an included angle θ between 25 and 30 degrees against a vertical central axis of the housing 2. As such, the radiating surface of the light-emitting unit 5 radiates upon a side surface of the flame decoration sheet 42 to simulate flames of candlelight.

The swinging member 6 is a soft rubber and disposed at the inner side of the housing 2 and away from the opening 25. Each of two sides of a lower end of the swinging member 6 is provided with a shaft 61. The shafts 61 are connected to the inner side of the first cover 21 and the inner side of the second cover 22, respectively. One end of the swinging member 6 away from the shafts 61 is provided with a magnetic element 62 being a magnet. An upper end of the magnetic element 62 of the swinging member 6 is extended to form an extension section 63 that corresponds to the protrusion 43. Thus, the shafts 61 and the housing 2 are connected to allow the swinging member 6 to perform axial rotation movements. Further, with corresponding contact between the extension section 63 and the protrusion 43, the holder 4 is driven to swing.

The driving member 7 is a coil and disposed at the inner side of the first cover 21 to correspond to the magnetic element 62.

The seat 8 is provided at a lower end of the housing 2, and is coupled on and fastened around a lower periphery of the first cover 21 and a lower periphery of the second cover 22. A bottom of the seat 8 is provided with a pin which is electrically connected to the driving member 7 and the light-emitting unit 5.

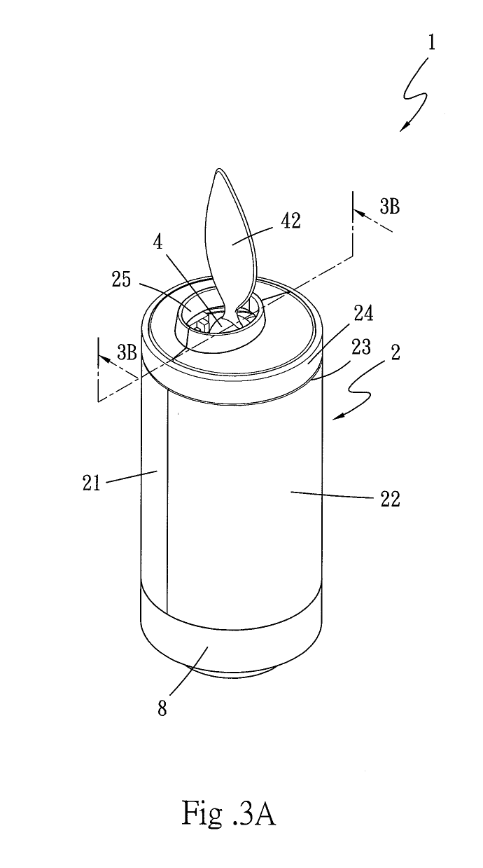

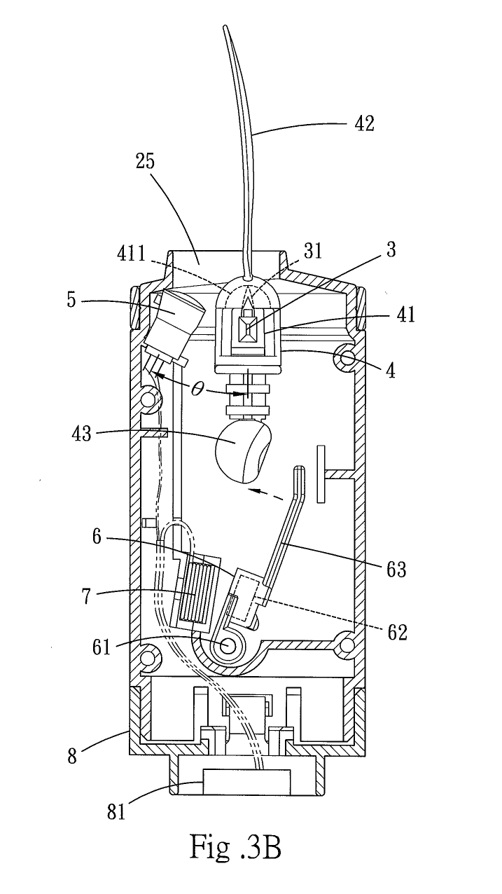

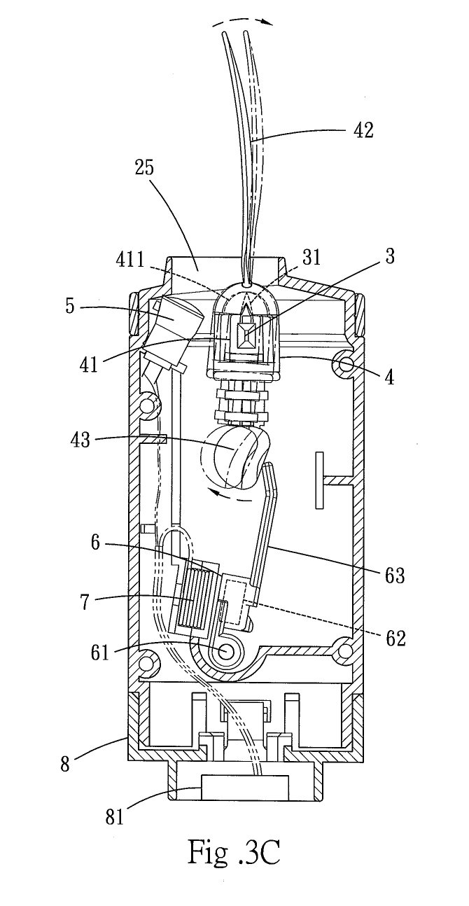

With the foregoing elements of the present invention, as shown in FIG. 3B and FIG. 3C, the pin 81 receives a signal pulse, and magnetic attraction is produced through induction between the driving member 7 and the magnetic element 62, such that the swinging member 6 produces axial rotation movements. Further, as the swinging member 6 is made of soft rubber, when the swinging member 6 swings to make the extension section 63 contact the protrusion 43 to push the holder 4, the volume caused by touching is effectively reduced. Further, the flame decoration sheet 42 exposed outside the opening 25 forms irregular swinging movements at different angles as the recess 411 of the through hole 41 of the holder 4 is abutted by the pointed section 31 of the positioning rod 3, thereby reinforcing realistic visual effect of a swaying and flickering candle flame. In addition, with the light from the light-emitting unit 5 radiating upon the flame decoration sheet 42, illumination as well as swinging visual effect of candlelight are simulated.

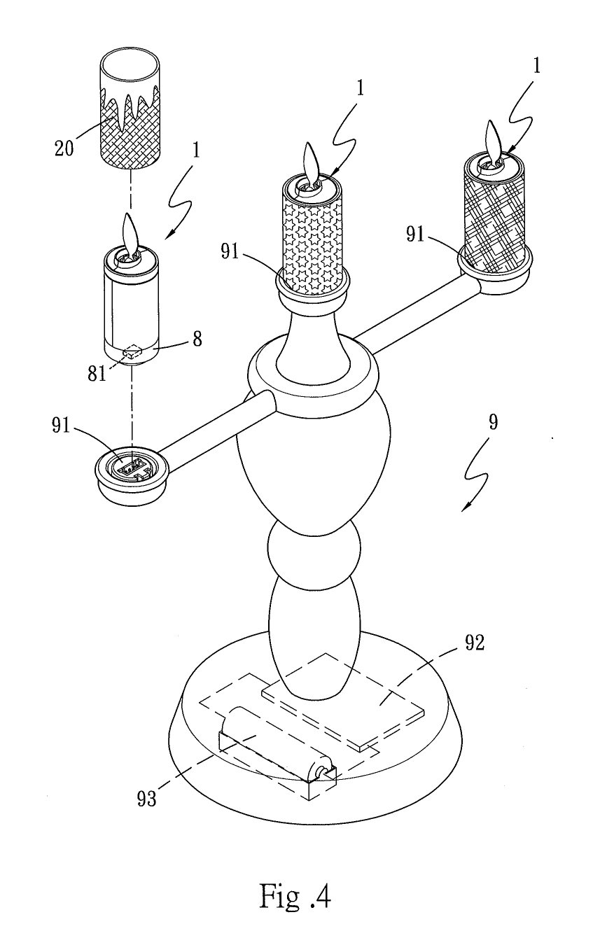

In the present invention, the electronic light-emitting device 1 is electrically connected to a socket 91. Referring to FIG. 4, in an embodiment, a lamp seat 9 of a lamp is taken as an example. The lamp seat 9 is provided with a plurality of sockets 91, and includes a control unit 92 and a power supply unit 93 therein. The control unit 92 is electrically connected to the power supply unit 93 and the sockets 91 to send signal pulses. The pins 81 of the electronic light-emitting devices 1 are correspondingly inserted and connected to the sockets 91 of the lamp seat 9. A surface of the electronic light-emitting device 1 is further coated by a cladding layer 20 which appears as a decoration that imitates a candle body. The power supply and the swinging movements of the electronic light-emitting device 1 can be at the same time controlled by the control unit 92 and the power supply unit 93 of the lamp seat 9. Further, with the electronic light-emitting device 1 and the lamp seat 9, the electronic light-emitting device 1 alone may be replaced when this electronic light-emitting device 1 is malfunctioning or damaged, so as to overcome the issue of wastes caused by a large number of the same functional elements that have to match the sockets one-on-one as in an occasion where a large number of electronic light-emitting devices are utilized. In the present invention, however, the seat 8 of the electronic light-emitting device 1 and the lamp seat 9 are separately disposed, the electronic light-emitting device 1 of the present invention offers reduced volume, weight, production costs and selling prices, and achieves effects of promoting environment protection as well as preventing fire accidents and human body burnt hazards.

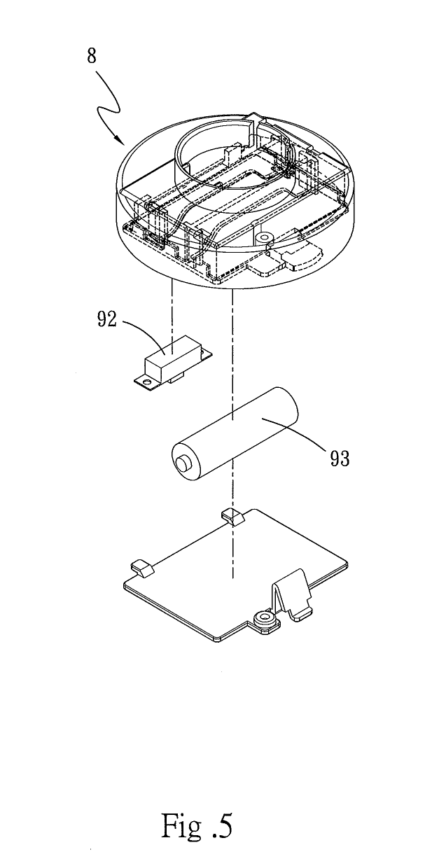

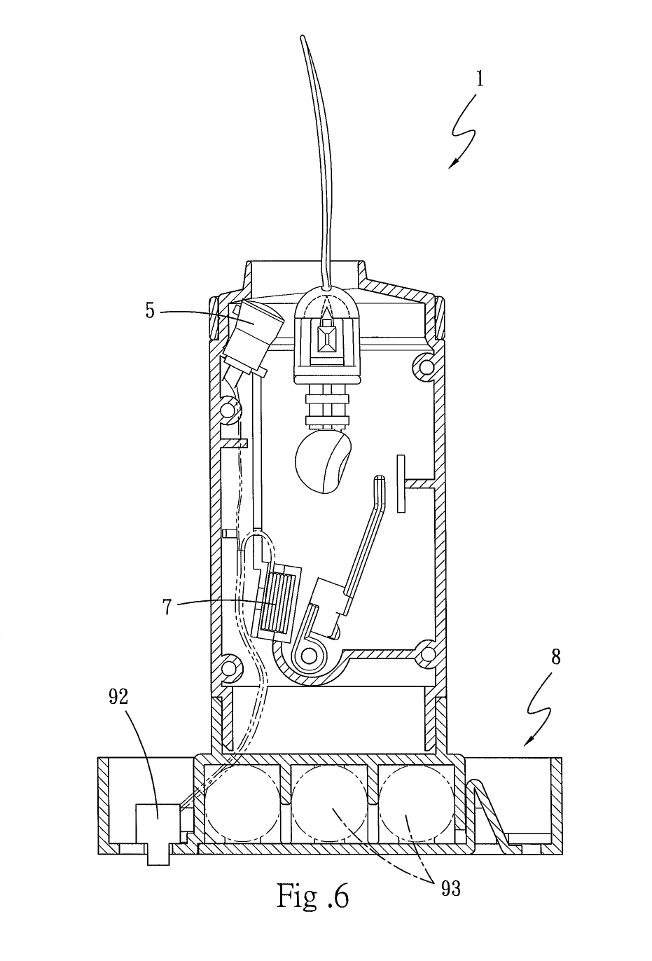

In another embodiment, the seat 8 of the electronic light-emitting device 1 combines functions of the lamp seat 9. Referring to FIG. 5 and FIG. 6, a control unit 92 and a power supply unit 93 are provided below the seat 9. The control unit 92 is electrically connected to the power supply unit 93, the driving member 7 and the light-emitting unit 5. The power supply and swinging movements of the electronic light-emitting device 1 are directly driven by the control unit 92 and the power supply unit 93. As such, the electronic light-emitting device 1 of the present invention may form an integral set that offers consumers with an additional option to select from.

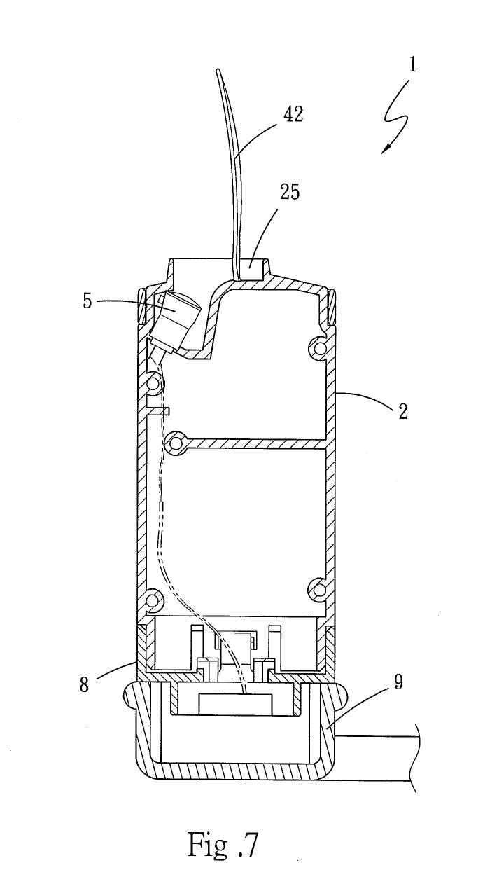

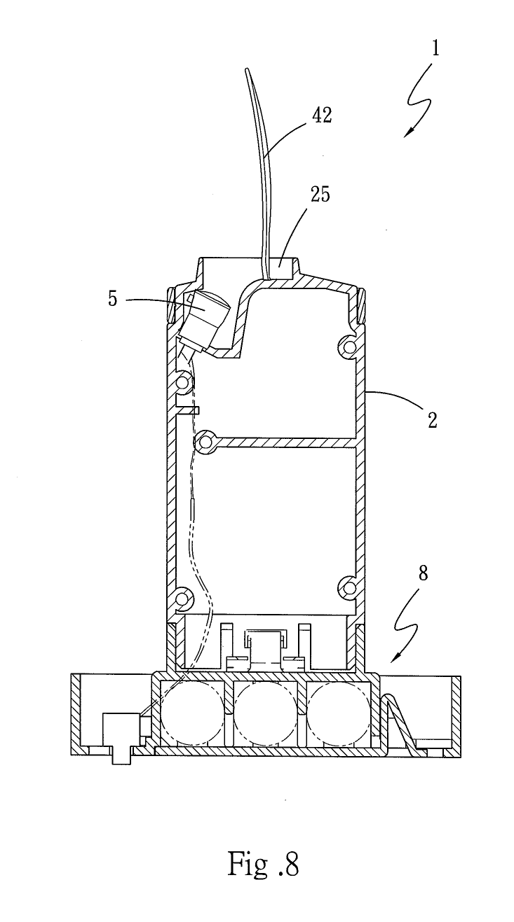

In yet another embodiment of the present invention, an upper end of the housing 2 of the electronic light-emitting device 1 is provided with an opening 25 and a flame decoration sheet 42 exposed outside the opening 25. A light-emitting unit 5 is provided at an inner side of the housing 2 and close to the opening 25. A radiating surface of the light-emitting unit 5 is corresponding to a side surface of the flame decoration sheet 42. A lower end of the housing 2 is connected to and provided with a seat 8, which may be implemented with the lamp seat 9 in a separate or integral form as in the foregoing description, as shown in FIG. 7 and FIG. 8. Thus, the electronic light-emitting device 1 of the present invention has a fixed flame decoration sheet 42 that does not swing to serve as a night lamp. The seat 8 of the electronic light-emitting device 1 of the present invention is further electrically connected to the light-emitting unit 5 to provide consumers with another choice to select from.

What is claimed is:

1. An electronic light-emitting device, comprising:
a housing, including an opening at an upper end thereof;
a positioning rod, connected to an inner side of the housing and close to the opening;
a holder, including a through hole penetrated by the positioning rod to allow the holder to be mounted on the positioning rod and a flame decoration sheet located at an upper end thereof and extended to expose outside the opening;
a light-emitting unit, disposed at the inner side of the housing and close to the opening, including a radiating surface corresponding to a side surface of the flame decoration sheet;
a swinging member, disposed at the inner side of the housing and away from the opening, including two shafts at two sides thereof to connect to the inner side of the housing, a magnetic element disposed thereon, and an extension section located at an upper end thereof and extended to correspondingly touch and push a lower end of the holder;
a driving member, disposed at the inner side of the housing to correspond to the magnetic element; and
a seat, connected to a lower end of the housing.

2. The electronic light-emitting device of claim 1, wherein the positioning rod includes a pointed section at an upper side thereof, and wherein the holder includes a protrusion at the lower end thereof that is touched and pushed by the extension section of the swinging member and a recess formed on a top wall of the through hole that is correspondingly abutted by the pointed section.

3. The electronic light-emitting device of claim 1, wherein the housing comprises a first cover and a second cover that correspondingly connect to each other, each of the first cover and the second cover includes an embedded groove on a periphery thereof that is coupled by a fastening ring for fastening.

4. The electronic light-emitting device of claim 1, wherein the radiating surface of the light-emitting unit forms an included angle between 25 and 30 degrees against a vertical central axis of the housing.

5. The electronic light-emitting device of claim 1, wherein the driving member is a coil, and the magnetic element is a magnet.

6. The electronic light-emitting device of claim 1, wherein the seat includes a pin at a bottom thereof electrically connected to the driving member and the light-emitting unit.

7. The electronic light-emitting device of claim 1 further comprising a control unit and a power supply unit below the seat, wherein the control unit is electrically connected to the power supply unit, the driving member and the light-emitting unit.

8. An electronic light-emitting device comprising a housing which includes an opening at an upper end thereof, a flame decoration sheet located at the upper end of the housing and extended to expose outside the opening, a light-emitting unit which is disposed at an inner side of the housing and close to the opening and includes a radiating surface corresponding to a side surface of the flame decoration sheet, and a seat connected to a lower end of the housing.

9. The electronic light-emitting device of claim 8, wherein the seat includes a pin at a bottom thereof electrically connected to the light-emitting unit.

10. The electronic light-emitting device of claim 8 further comprising a control unit and a power supply unit below the seat, wherein the control unit is electrically connected to the power supply unit and the light-emitting unit.
